(19) United States
(12) Patent Application Publication
(10) Pub. No.: US 2006/0137312 A1
(43) Pub. Date: Jun. 29, 2006

(54) Positioning device for the dust-collecting bag of a dust-collecting machine

(75) Inventor: Chieh-Yuan Cheng, Taichung (TW)

Correspondence Address: TROXELL LAW OFFICE PLLC, SUITE 1404, 5205 LEESBURG PIKE, FALLS CHURCH, VA, 22041, US

(73) Assignee: San Ford Machinery Co., Ltd.

(21) Appl. No.: 11/023,568

(22) Filed: Dec. 29, 2004

(51) Int. Cl. B01D 46/02

(52) U.S. Cl. 55/378

(57) ABSTRACT

A positioning device for the dust-collecting bag of a dust-collecting machine includes a wind-exhausting box having its annular wall bored with an annular engaging groove and plural positioning members. Each positioning member is formed with a combining portion secured on the annular wall at the inner side of the annular engaging groove. The combining portion has one end extending and bent to form a clamping portion having its inner side formed with an arc-shaped projection to be engaged with the annular engaging groove of the annular wall. The clamping portion has its lower end extending outward obliquely and forming a pull member. When a dust-collecting bag is fitted around the annular wall, its opening portion can be elastically clamped by the clamping portions of and closely engaged in the annular engaging groove of the annular wall.

### BACKGROUND OF THE INVENTION

1. Field of the Invention

This invention relates to a positioning device for the dust-collecting bag of a dust-collecting machine, particularly to one able to firmly position a dust-collecting bag on a dust-collecting machine in advance for facilitating sequent fixing of the dust-collecting bag.

2. Description of the Prior Art

A conventional medium-sized or large-sized dust-collecting machine is generally provided with a wind-exhausting box fixed thereon with a securing ring for the opening portion of dust-collecting bag to be fitted and positioned thereon, and then the opening portion of the dust-collecting bag is tightened and secured on the securing ring by an annular hoop. However, after the large-sized opening portion of the dust-collecting bag is fitted around the securing ring, if the opening portion is not fixed or held in advance, it is hard for one person to fit and tighten the annular hoop on the opening portion of the dust-collecting bag. Therefore, a clamping plate able to fix and position a dust-collecting bag in advance is designed and employed. This elongate clamping plate 10, as shown in FIG. 1, to be secured on the circumferential wall of the outlet of the wind-guiding pipe of a dust-collecting machine has its upper part bored with combining holes 11, its intermediate part bent and formed with an arc-shaped portion 12 and its lower end formed with a reversely bent part 13. The arc-shaped portion 12 has its upper and lower end respectively formed with a first clamping edge 14 and a second clamping edge 15, and the reversely bent part 13 has its bent border formed with a third clamping edge 16. After the opening portion of a dust-collecting bag is fitted around the circumferential wall of the wind-exhausting pipe, these clamping edges 14, 15, 16 are able to clamp and position the opening portion of the dust-collecting bag to prevent the dust-collecting bag from slipping off.

However, the contact surfaces of the first, the second and the third clamping edge 14, 15, 16 of the clamping plate 10 as well as the corresponding circumferential wall of the wind-exhausting pipe are straight and even; therefore, their clamping force applied to the body of the dust-collecting bag is in a vertical direction, having no function of engagement and resistance and unable to firmly fix the dust-collecting bag in position.

### SUMMARY OF THE INVENTION

The objective of the invention is to offer a positioning device for the dust-collecting bag of a dust-collecting machine, provided with a wind-exhausting box and a plurality of positioning members. The wind-exhausting box has its annular wall bored with an annular engaging groove. Each positioning member is formed with a combining portion secured on the annular wall at the inner side of the annular engaging groove. The combining portion has one end extending and bent to form a clamping portion having its inner side formed with an arc-shaped projection to be closely engaged with the annular engaging groove of the annular wall. The clamping portion has its lower end extending outward obliquely and forming a pull member. When a dust-collecting bag is fitted around the annular wall, its opening portion can be elastically and firmly clamped by the arc-shaped projections of the positioning members and also closely engaged in the annular engaging groove of the annular wall, able to clamp and position a dust-collecting bag firmly to prevent it from slipping off.

### BRIEF DESCRIPTION OF DRAWINGS

This invention will be better understood by referring to accompanying drawings, wherein:

FIG. 1 is a perspective view of a conventional dust-collecting bag positioning plate:

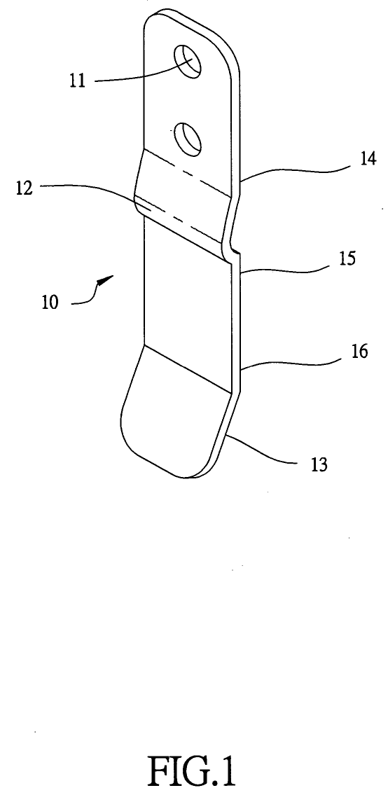

FIG. 2 is a front view a dust-collecting machine in the present invention:

FIG. 3 is a side-sectional view of a positioning member assembled on the dust-collecting machine in the present invention:

FIG. 4 is a perspective view of the positioning member assembled on the dust-collecting machine in the present invention:

FIG. 5 is an exploded perspective view of the positioning member in the present invention:

FIG. 6 is a side-sectional view of the dust-collecting machine in the present invention, showing that the dust-collecting bag is positioned in advance on the dust-collecting machine: and

FIG. 7 is a side-sectional view of the dust-collecting machine in the present invention, showing that the positioning member is pulled open.

### DETAILED DESCRIPTION OF THE PREFERRED EMBODIMENT

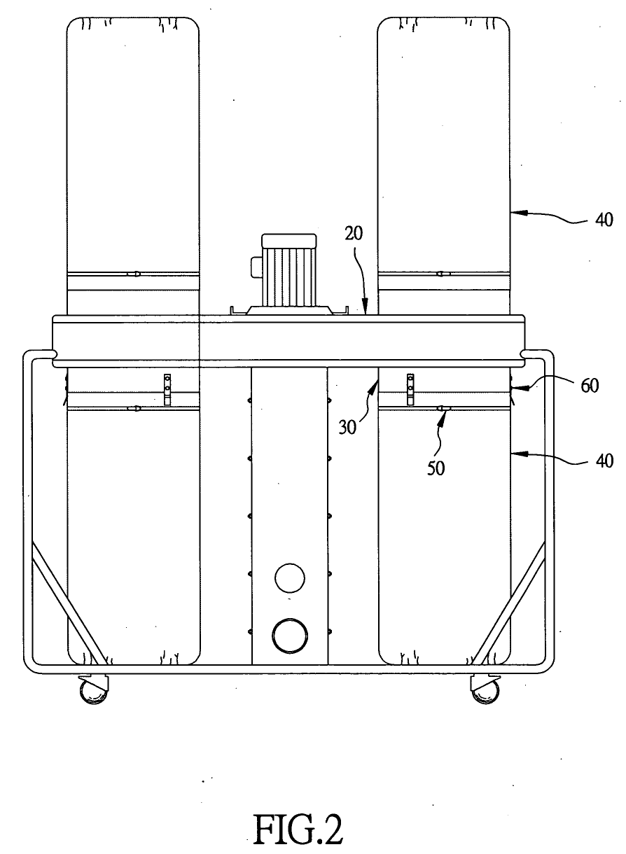

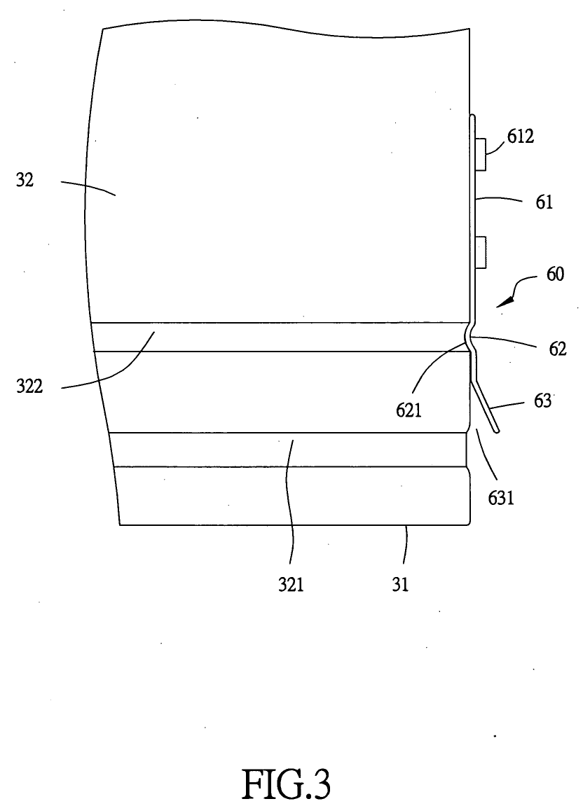

A preferred embodiment of a positioning device for the dust-collecting bag of a dust-collecting machine in the present invention, as shown in FIGS. 2 and 3, includes a wind-exhausting box 20, a plurality of securing rings 30, a dust-collecting bag 40, an annular hoop 50 and a plurality of positioning members 60. Each toggle 30 assembled on the wind-exhausting box 20 is formed with an annular tightening recess 321 around its annular wall 32 near a wind-exhausting port 31. Thus, when a dust-collecting bag 40 has its opening portion 41 fitted and positioned around the annular wall 32 of the toggle 30, it can be fixed and positioned in the annular tightening recess 321 by means of the annular hoop 50. In addition, an annular engaging groove 322 is bored at the annular wall 32 at the inner side of the annular tightening recess 321. The positioning members 60 are secured on the annular wall 32 at the inner side of the annular engaging groove 322 for clamping and positioning the dust-collecting bag 40 before the dust-collecting bag 40 is firmly fixed in the annular tightening recess 321 by the annular hoop 50.

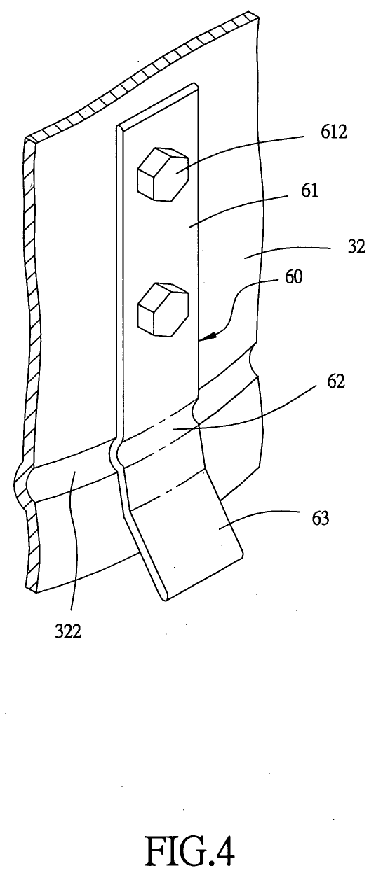

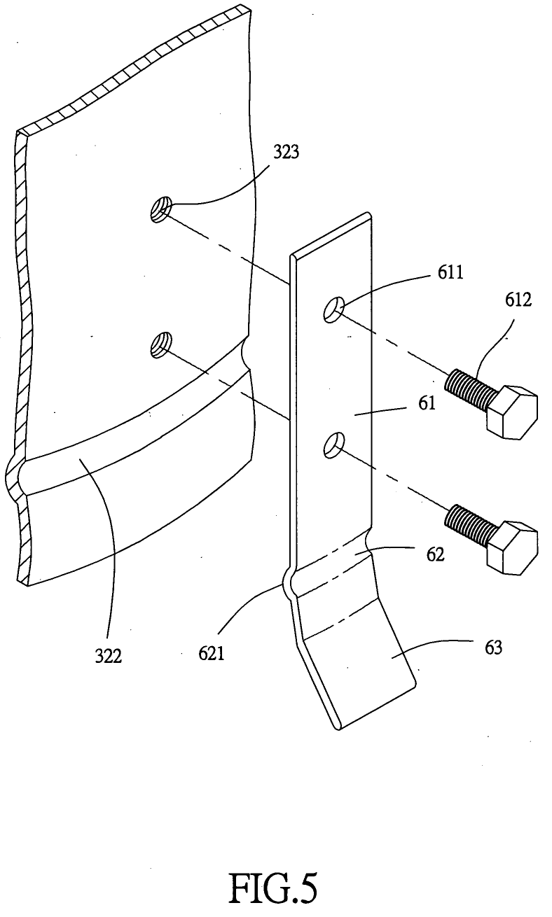

Each securing ring 30, as shown in FIGS. 4 and 5, is bored with plural threaded holes 323 in the annular wall 32 at the inner side of the annular engaging groove 322.

Each positioning member 60 shaped as an elongate plate is formed with a straight and even combining portion 61 bored with plural insert holes 611 respectively aligned to the threaded holes 323 of the securing ring 30 so that the combining portion 61 of the positioning member 60 can be secured on the annular wall 32 by bolts 612 inserted through the insert holes 611 and screwed with the threaded holes 323. In addition, the combining portion 61 has one end formed with an arc-shaped clamping portion 62 extending toward the annular wall 32 and having its inner side formed with an arc-shaped projection 621 exactly able to be elastically and closely engaged in the annular engaging groove 322 of the annular wall 32. The arc-shaped clamping portion 62 has its lower end extending outward obliquely and forming a pull member 63 slanting away from the annular wall 32, with a pull opening 631 preset in size formed between the end of the pull member 63 and the annular wall 32.

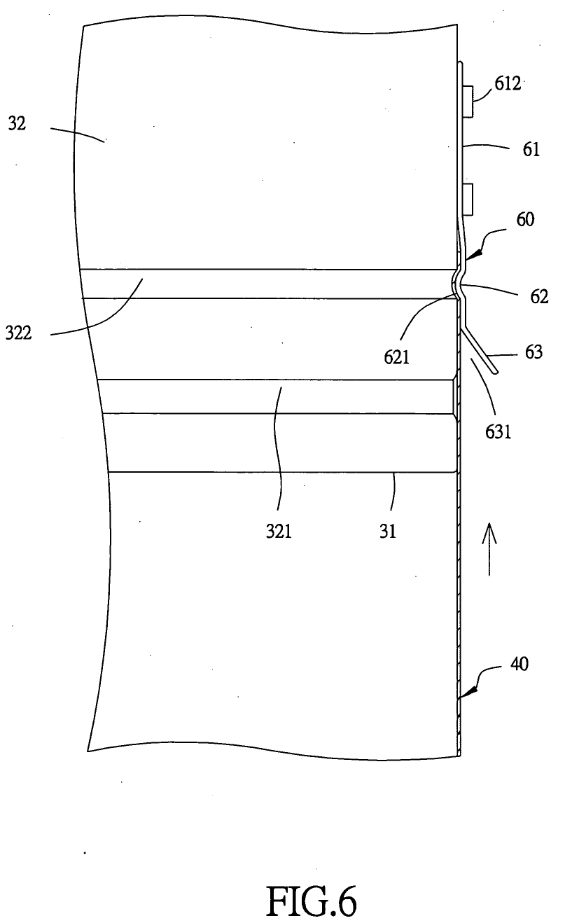

In using of the positioning members 60, as shown in FIGS. 3 and 6, the opening portion 41 of the dust-collecting bag 40 is fitted around the annular wall 32 of the securing ring 30 and pulled inward to pass through between the pull opening 631 between the positioning member 60 and the annular wall 32 and reach the clamping portion 62 of the positioning member 60. At this time, only apply a little force to prop open the clamping portion 62 and move the opening portion 41 of the dust-collecting bag 40 to reach the abutment of the clamping portion 62 and the combining portion 61 and then let go of the dust-collecting bag 40. Simultaneously, the clamping portion 62 of the positioning member 60 will recover its resilience to clamp the opening portion 41 of the dust-collecting bag 40 to have it closely positioned in the engaging groove 322 of the annular wall 32 to finish positioning the dust-collecting bag 40 in advance. Subsequently, the dust-collecting bag 40 is tightened and fixed in position by the annular hoop 50.

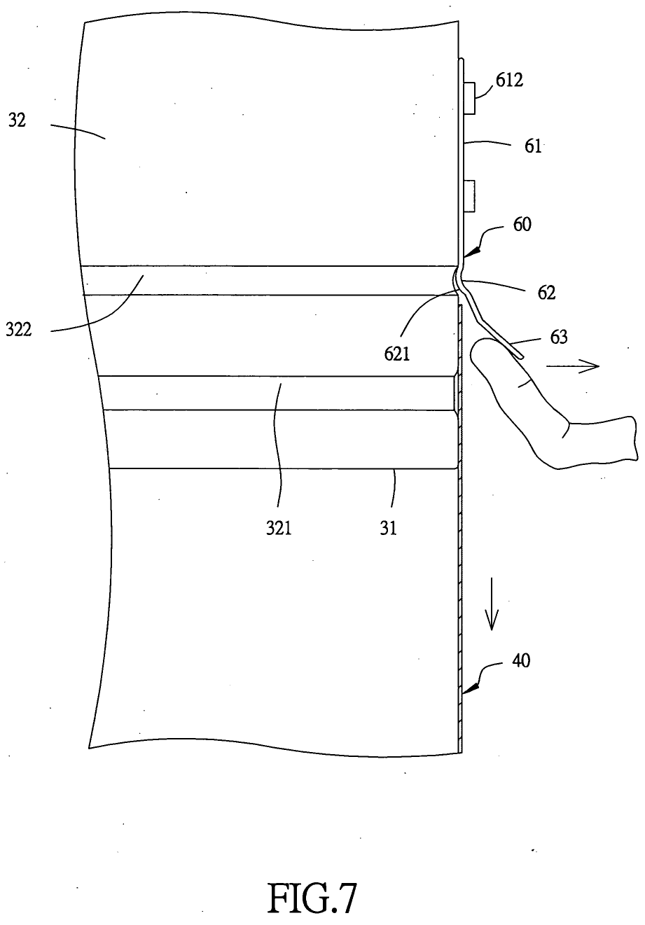

To remove the dust-collecting bag 40 from the annular wall 32, as shown in FIG. 7, only slightly pull open the pull member 63 of the positioning member 60 to let the opening portion 41 of the dust-collecting bag 40 released from clamping of the clamping portion 62. At this time, the dust-collecting bag 40 can be pulled downward and removed.

More specifically, the engaging portion 62 of the positioning member 60 has pressing resilience relative to the combining portion 61, and the arc-shaped projection 621 of the engaging portion 62 and the annular engaging groove 322 of the annular wall 32 are respectively arc-shaped for engaging each other; therefore, the opening portion 41 of the dust-collecting bag 40 can be clamped by the arc-shaped projection 621 and also engaged firmly in the arc-shaped annular engaging groove 322, able to firmly fix the dust-collecting bag 40 in position to prevent it from slipping off.

While the preferred embodiment of the invention has been described above, it will be recognized and understood that various modifications may be made therein and the appended claims are intended to cover all such modifications that may fall within the spirit and scope of the invention.

I claim:

1. A positioning device for the dust-collecting bag of a dust-collecting machine comprising a plurality of positioning members, said positioning members positioning a dust-collecting bag in advance after said dust-collecting bag is fitted around the annular wall near the wind outlet of the wind exhausting box of a dust-collecting machine, said dust-collecting bag firmly fixed on said annular wall of said wind-exhausting box by an annular hoop after it is positioned by said positioning members: and characterized by,
Said wind-exhausting box having the outer annular wall near its wind outlet formed with an annular engaging groove at a proper location: and
Said positioning member shaped as an elongate plate, said positioning member formed with a straight and even combining portion, said combining portion of said positioning member axially secured on the outer annular wall of said wind-exhausting box at the inner side of said annular engaging groove, said combining portion having one end extending and bent to form an arc-shaped clamping portion protruding toward said annular wall, said clamping portion having its inner side formed with an arc-shaped projection, said arc-shaped projection of said clamping portion exactly able to be elastically and closely engaged in said annular engaging groove of said annular wall, said clamping portion having its lower end extending outward obliquely and forming a pull member, with a pull opening of a preset size formed between said pull member and said annular wall, the opening portion of said dust-collecting bag moved along said annular wall and passing through both said pull opening and said clamping portion to reach the upper edge of said clamping portion, said opening portion of said dust-collecting bag able to be clamped in position by said arc-shaped projections of said clamping portions of said positioning members and engaged in said annular engaging groove of said annular wall.

2. The positioning device for the dust-collecting bag of a dust-collecting machine as claimed in claim 1, wherein said combining portion of each said positioning member is bored with at least one insert hole, and said annular wall is bored with at least one threaded hole aligned to said insert hole of said positioning member, said positioning members secured on said annular wall by bolts inserted through said insert holes and said threaded holes.
